(19) United States
(12) Patent Application Publication
(10) Pub. No.: US 2015/0221026 A1
(43) Pub. Date: Aug. 6, 2015

(54) FUND MANAGEMENT SYSTEM AND FUND MANAGEMENT METHOD

(71) Applicant: Jin Kyu Hong, Seongnam (KR)

(72) Inventor: Jin Kyu Hong, Seongnam (KR)

(21) Appl. No.: 14/419,238

(22) PCT Filed: Aug. 3, 2013
(86) PCT No.: PCT/KR2013/007017

§ 371 Date: Apr. 11, 2015

(30) Foreign Application Priority Data
Aug. 3, 2012 (KR) 10-2012-0085400

(51) Int. Cl. G06Q 40/00

(52) U.S. Cl. CPC G06Q 40/00

(57) ABSTRACT

Disclosed are a fund management system and a fund managing method. The system of managing funds includes a fund collecting unit configured to collect a first type fund and a second type fund depending on a preset reference rate; a fund managing unit configured to manage at least one of summed funds which are acquired by incorporating funds collected through the first type fund into funds collected through the second type fund and summing these funds, and establish a capital protection amount in the second type fund to separately manage the funds collected through the first type fund from the managed summed fund when a loss of the capital protection amount or more occurs; and a return sharing unit configured to share a return generated depending on a fund management with the first type fund and the second type fund, respectively, depending on a preset return sharing ratio.

### TECHNICAL FIELD

The present invention relates to a fund management system and a fund managing method. More particularly, the present invention relates to a fund management system and a fund managing method which manage funds so as to provide a high leverage effect to aggressive investors and minimize a loss for defensive investors, in consideration of investment tastes of the investors.

### BACKGROUND ART

A goal of fund investment is to obtain an investment return higher than direct investment while securing investment safety by indirect investment which deposits investment funds into a specialist managing a fund. To minimize a risk of losing money in a stock market having large volatility under which investors are hard to predict, fund products have been always interested by investors. To respond thereto, various types of fund products which suit an investor taste have emerged.

The rate of return on funds has a difference depending on investment targets, but a conventional fund management system is managed as a system which determines market conditions to minimize a loss of investors and gain a higher return, and if it is determined that the stock market is in a bullish market, automatically increases a stock position or automatically sells the security holdings, and the like, while if it is determined that the stock market is in a bearish market, automatically increases a bond position and automatically buys the security holdings, and the like.

However, the conventional fund management system has a problem in that even the defensive investors who pursue safety may not avoid the risk of losing money in a long-term market decline or when the overall market condition is not desirable due to external factors.

Further, the conventional fund management system has a problem in that it is hard for the aggressive investors to obtain a sufficient leverage effect because they do not have a significant established amount of funds.

### DISCLOSURE

### Technical Problem

Accordingly, it is an object of the present invention to provide a fund management system and a fund managing method capable of maximizing returns of both of defensive investors and aggressive investors using one fund product.

Another object of the present invention is to provide a fund management system and a fund managing method capable of preventing a loss of principal for defensive investors.

Still another object of the present invention is to provide a fund management system and a fund managing method capable of elastically managing funds depending on market conditions or investor tastes by variously establishing a capital protection amount.

### Technical Solution

In order to accomplish the above objects, according to one aspect of the present invention, there is provided a system of managing funds, including: a fund collecting unit configured to collect a first type fund and a second type fund depending on a preset reference rate; a fund managing unit configured to manage at least one of summed funds which are acquired by incorporating funds collected through the first type fund into funds collected through the second type fund and summing these funds, and establish a capital protection amount in the second type fund to separately manage the funds collected through the first type fund from the managed summed fund when a loss of the capital protection amount or more occurs; and a return sharing unit configured to share a return generated depending on a fund management with the first type fund and the second type fund, respectively, depending on a preset return sharing ratio.

The fund managing unit may automatically repurchase the funds collected through the first type fund and the second type fund when a loss of the capital protection amount or more occurs.

The fund managing unit may incorporate at least a portion of the funds of the first type fund among management funds with a loss into the summed funds with a return based on the reference rate when a return is generated depending on the fund management to readjust an establishment amount of the first type fund and the second type fund and manage the funds.

When a loss occurs depending on the fund management, the return sharing unit may share at least a portion of trading returns including at least one of a sale commission and a management return which are generated by the collection of funds or the management of summed funds with the first type fund.

A plurality of capital protection amounts may be established by the fund collecting unit or the fund managing unit.

The fund managing unit may invest the fund of the collected fund in at least one of stock, futures and option products, and foreign products, or directly invests at least a portion of the funds managed by the second type fund in a trading market depending on a selection of an investor.

According to another aspect of the present invention, there is provided a method of managing funds, including: collecting, by a fund managing unit, a first type fund and a second type fund depending on a preset reference rate; incorporating, by a fund managing unit, the funds collected through the first type fund into the funds collected through the second type fund and summing these funds to manage at least one summed fund; establishing, by the fund managing unit, a capital protection amount in the second type fund to manage the funds; separating, by the fund managing unit, the funds collected through the first type fund from the managed summed funds when a loss of the capital protection amount or more occurs; and sharing, by a return sharing unit, a return generated depending on the fund management with the first type fund and the second type fund, respectively, depending on a preset return sharing ratio.

In the separating of the fund, the funds collected through the first type fund and the second type fund may be automatically repurchased when a loss of the capital protection amount or more occurs.

In the managing of the fund, when a return is generated depending on the fund management, at least a portion of the funds of the first type fund among the summed funds with a loss may be incorporated into the summed funds with a return based on the reference rate to readjust an establishment amount of the first type fund and the second type fund and manage the funds.

In the sharing of the return, when a loss occurs depending on the fund management, at least a portion of trading returns including at least one of a sale commission and a management return which are generated by the collection of funds or the management of summed funds may be shared to the first type fund.

In the managing of the fund, a plurality of capital protection amounts may be established to manage the funds.

In the managing of the fund, the fund of the collected fund may invest to at least one of stock, futures and option products, and foreign products, or at least a portion of the funds managed by the second type fund directly invests to a trading market depending on a selection of an investor.

### Advantageous Effects

In accordance with the fund management system and the fund managing method according to the present invention, it is possible to maximize the returns of both of defensive investors and aggressive investors using one fund product.

Further, in accordance with the fund management system and the fund managing method according to the present invention, it is possible to prevent a loss of principal for defensive investors.

Furthermore, in accordance with the fund management system and the fund managing method according to the present invention, it is possible to elastically manage the funds depending on the market conditions or the investor tastes by variously establishing the capital protection amount.

### DESCRIPTION OF DRAWINGS

FIG. 1 is a block diagram illustrating a configuration of a fund management system according to the present invention.

FIG. 2A is a block diagram illustrating a configuration of a server of the fund management system according to the present invention.

FIG. 2B is a block diagram illustrating a detailed configuration of the server of the fund management system according to the present invention.

FIG. 3 is a diagram for describing a process of readjusting funds when returns are generated in the fund management system according to the present invention.

FIG. 4 is a diagram for describing a process of readjusting funds when a loss occurs by the fund management system according to the present invention.

FIG. 5 is a diagram for describing a process of separating a first type fund depending on a capital protection amount established in the fund management system according to the present invention.

FIG. 6 is a diagram for describing a process of sharing returns when returns are generated in the fund management system according to the present invention.

FIG. 7 is a flow chart illustrating a fund managing method according to the present invention.

### BEST MODE

Hereinafter, a fund management system and a fund managing method according to the present invention will be described in detail with reference to the accompanying drawings.

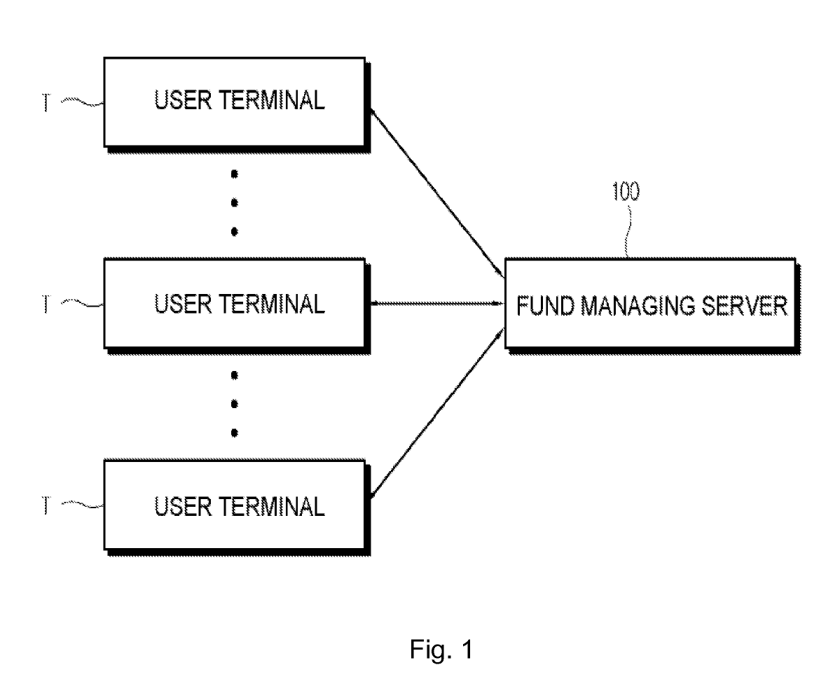

FIG. 1 is a block diagram illustrating a configuration of a fund management system according to the present invention. As illustrated in FIG. 1, the fund management system according to the present invention includes a user terminal T and a server 100 for managing funds.

The user terminal T includes wired and wireless communication modules to be connected to the server 100, and an input device for inputting information, and may include a display unit which displays various information on fund products. The user terminal according to the present invention may be implemented as a personal computer, a smart phone, a tablet PC, a PDA, and the like. The configuration for checking and selecting the fund products is well known in the art, and therefore will not be described in detail.

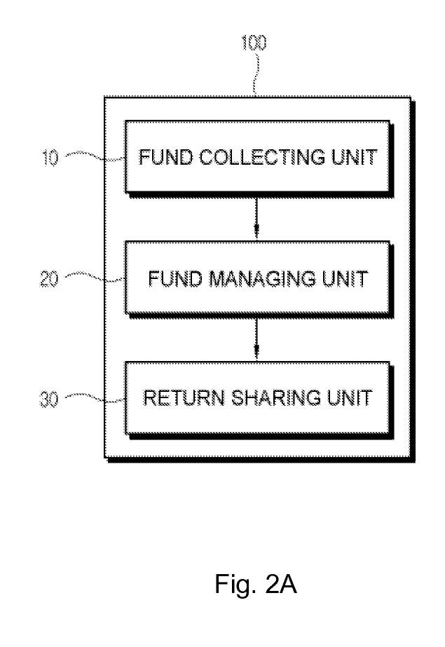

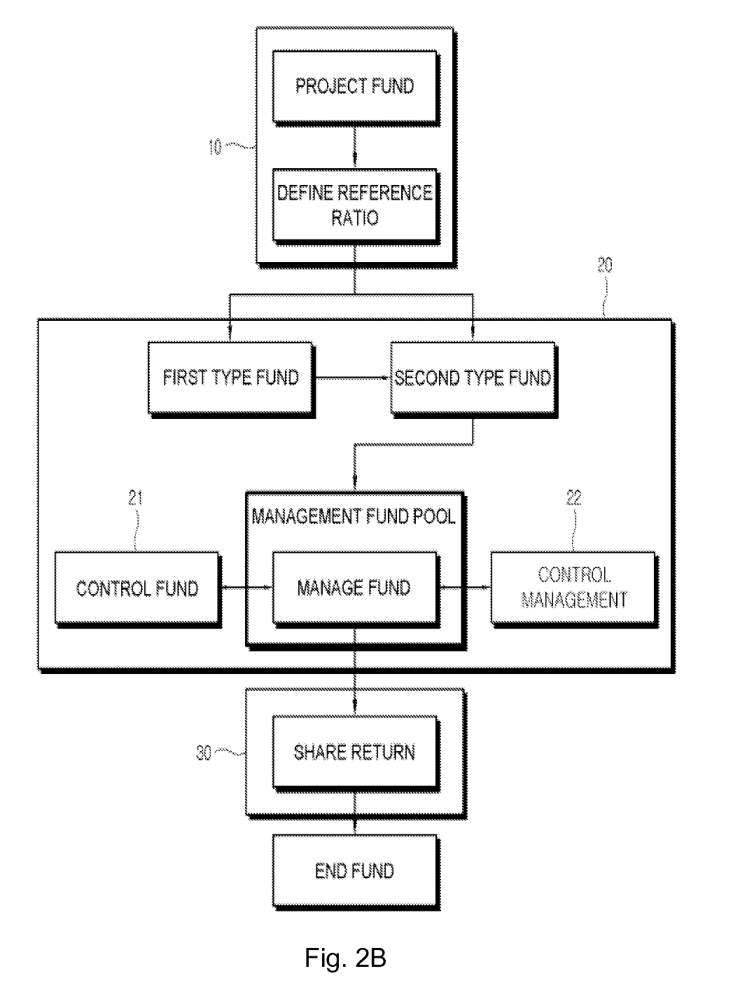

FIGS. 2A and 2B are block diagrams illustrating a configuration of the server 100 included in the fund management system according to the present invention. As illustrated in FIG. 2A, the server 100 according to the present invention includes a fund collecting unit 10, a fund managing unit 20, and a return sharing unit 30.

The server 100 according to the present invention may be configured to include a microcomputer for performing operations of each component, a database which stores software and information for managing funds, and the like.

The fund collecting unit 10 stores information according to a fund project as illustrated in FIG. 2B, and sets a reference rate to collect a first type fund and a second type fund depending on the preset reference rate. Kinds of fund products may be divided depending on the reference rate of the first type fund and the second type fund, and the user terminal may receive user interface information provided from the fund collecting unit 10 to enable users to select their desired fund products.

Herein, the first type fund and the second type fund are divided in consideration of investor tastes. The first type fund may include defensive funds which have a low rate in both of return and loss possibility, and the second type fund may include aggressive funds which have a high rate in both of return and loss possibility. The first type fund which means the defensive fund is suitable for investors who want to avoid a loss of principal and predict a stable return, while the second type fund which means the aggressive fund is suitable for investors who want to maximize a rate of return even though a loss of principal may occur.

The fund management system according to the present invention sums both of funds collected as defensive funds and funds collected as aggressive funds to invest the summed funds in an investment target. Therefore, the aggressive investors may use the funds collected as the defensive funds to maximize a leverage effect.

The fund collecting unit 10 according to the present invention: provides fundamental information such as information on a rate of return per a period of time for each fund product with a defined reference rate, information on fund management companies, and information on sales, repurchase commissions, and management returns to users who are investors; receives a kind of fund products, fund types, a payment amount, and the like; and provides the received information to the fund managing unit 20. Like other fund products, the fund products provided from a fund management system including the server 100 (hereinafter referred to as a fund management system or fund managing server) according to the present invention may be present as a lump sum type product, a cost averaging type product, and a free payment type product.

The fund managing unit 20 manages at least one fund of summed funds which are acquired by incorporating funds collected through the first type fund into funds collected through the second type fund and summing these funds, and establishes a capital protection amount in the second type fund to separately manage the summed funds collected through the first type fund from the managed summed fund when a loss of the capital protection amount or more occurs. Herein, a plurality of summed funds may be separately managed depending on the targeted established amount. More preferably, the fund managing unit 20 may automatically repurchase the funds collected through the first type fund and the second type fund when the loss of the capital protection amount or more occurs.

The fund management system according to the present invention divides funds into the first type fund and the second type fund by using the fund collecting unit 10, but the fund managing unit 20 incorporates the funds collected through the first type fund into the funds collected through the second type fund and manages the summed fund to provide the maximized leverage effect to investors who select the second type fund. Further, when a loss occurs, the occurring loss is applied to the fund collected through the second type fund, and as a result, investors who select the first type fund do not suffer from a loss.

As illustrated in FIG. 2B, the fund managing unit 20 according to the present invention may further include a fund controller 21 and a management controller 22 which controls an overall operation of fund management.

When a return or a loss is generated depending on the fund management during managing the collected fund, the fund controller 21 readjusts the established amount of the first type fund and the second type fund based on the reference rate set by the fund collecting unit 10 and manages the readjusted funds.

The management controller 22 establishes an investment market when the fund collecting unit 10 completes fund collection, establishes a trading unit when the establishment of the investment market is completed, and establishes an investment environment when the establishment of the trading unit is completed. Herein, the investment market may include a stock, futures and option, or an investment market of foreign products. The investment environment may be established by receiving information required for trading in each investment market from the fund collecting unit 10 or the user. To this end, the fund collecting unit 10 and the management controller 22 may provide a user interface for receiving information from the user input to the user terminal T.

When the management controller 22 establishes the investment environment, the fund managing unit 20 according to the present invention determines that the management conditions are satisfied to determine whether the fund collection by the fund collecting unit 10 is completed. As a result, if it is determined that the fund collection is completed, the fund managing unit continuously manages the funds to meet a fund scale which is set by the fund controller 21.

The fund managing unit 20 according to the present invention may invest various investment targets such as stock, futures and option products, and foreign products. Herein, when the funds invest in a stock product, the summed fund itself may be used, but in the case of the futures and option products or the foreign products, a process of dividing an available summed fund into one account deposit fund for converting a management unit is required.

Further, the fund managing unit 20 according to the present invention may directly invest at least a portion of the summed funds of the second type fund to a trading market by a selection of the investors. In particular, investors who invest in the second type fund pursue a high rate of return and may directly determine investment timing in the trading market depending on market conditions by using the fund managing unit 20 according to the present invention, thereby overcoming, in particular, a limitation of a cost averaging fund wherein a constant amount is automatically incorporated on a predetermined date.

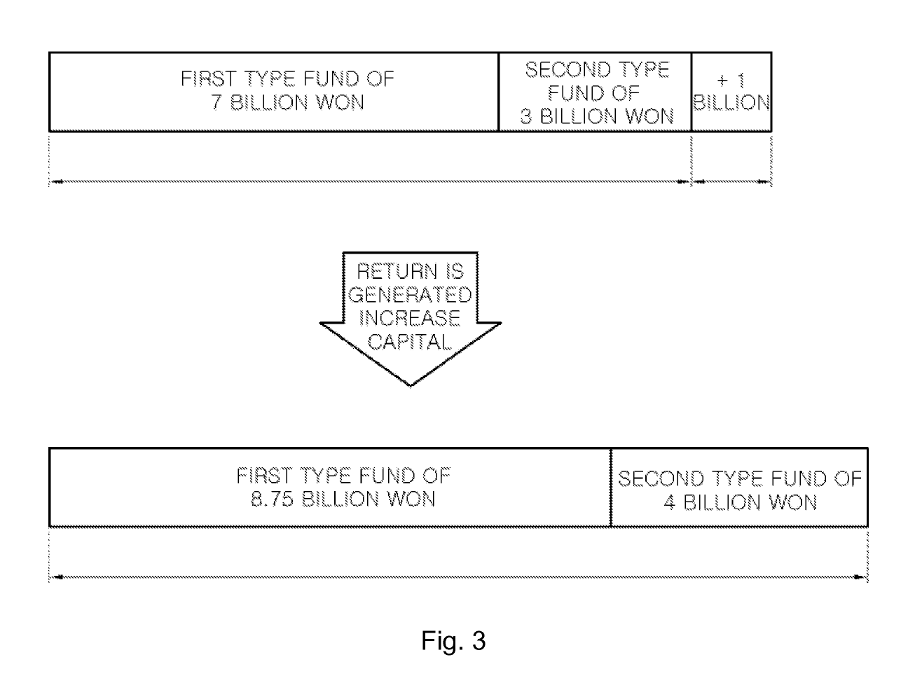

FIG. 3 is a diagram for describing a process of readjusting an established amount of the first type fund and the second type fund when a return is generated by the fund management system 100 according to the present invention. As illustrated in FIG. 3, for example, when the first type fund collects 7 billion won, the second type fund collects 3 billion won, and a return of 1 billion won is generated, the generated return is applied to the second type fund to increase the funds of the second type fund to 4 billion, and then the amount of the first type fund is readjusted to 8.75 billion won based on the amount of the second type fund to meet a reference rate of the first type fund and the second type fund, that is, a ratio of 7:3. Thereby, a total summed fund is increased to 12.75 billion won. A fund required to increase the summed fund, that is, a fund required to increase the summed fund to which a return is applied is obtained from a reduction of money of the first type fund of the summed fund with a loss among other summed funds. Herein, the reduction money means money reduced depending on the preset reference rate when a loss occurs and serves as payment reserves.

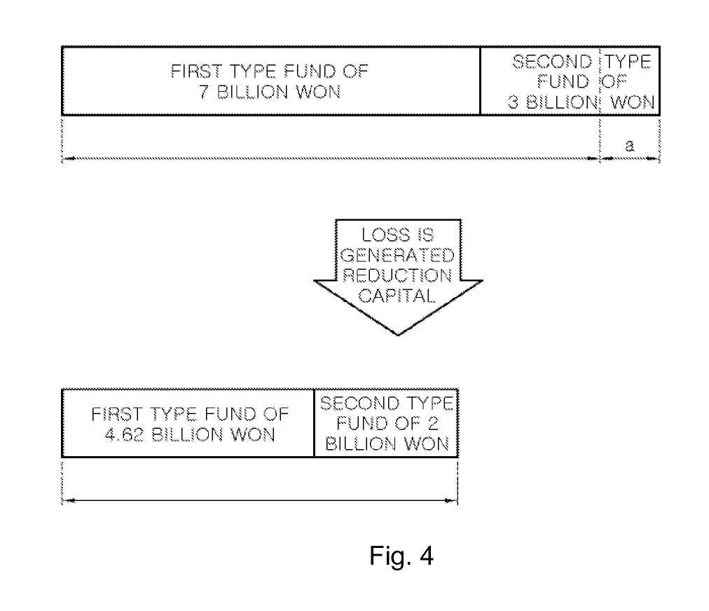

FIG. 4 is a diagram for describing a process of readjusting an established amount of a first type fund and a second type fund when a loss occurs by the fund management system 100 according to the present invention. As illustrated in FIG. 4, for example, when the first type fund collects 7 billion won, the second type fund collects 3 billion won, and then a loss of 1 billion won occurs, the occurring loss is applied to the second type fund to reduce the funds of the second type fund to 2 billion, and then the amount of the first type fund is readjusted to 4.62 billion won based on the amount of the second type fund to meet a reference rate of the first type fund and the second type fund, that is, a ratio of 7:3. Thereby, a total summed fund is reduced to 6.62 billion won.

FIGS. 3 and 4 describe the case in which a return or a loss is generated in the fund management system 100 according to the present invention. When the return is generated, funds required to increase the total summed fund may be obtained by withdrawing the funds of the first type fund in fund products with a loss.

That is, the fund management system 100 according to the present invention manages the funds collected through the second type fund during collecting and managing funds through a plurality of fund products. In this case, when a return is generated during managing funds, the fund management system according to the present invention incorporates the funds of the first type fund to maximize the return so as to increase the summed fund. When a loss occurs, the fund management system according to the present invention withdraws the funds of the first type fund to minimize the loss so as to reduce the summed fund. The readjusting of the summed fund is made by incorporating at least a portion of the funds of the first type fund among the summed fund with a loss into the summed fund with a return. Therefore, the fund management system 100 according to the present invention obtains money from the summed funds of the fund with a loss to pay the return to the fund with a return. When the investors investing in the corresponding summed fund with a loss withdraws the investment funds, funds required to prevent a loss of investors investing in the first type fund may be obtained from the payment reserves of another first type fund. That is, when the investors want to realize a return or withdraw money, funds move from the summed fund with a loss to the summed fund with a return. When the fund is managed by a single summed fund, not by a plurality of summed funds, funds move from the first type fund of another account to an account with a return.

Meanwhile, the fund managing unit 20 according to the present invention establishes the capital protection amount in the amount collected through the second type fund, thereby preventing the loss of the investors who select the first type fund. Herein, when the capital protection amount is in an amount within the second type fund, the capital protection amount may be freely established as any amount and the capital protection amount means a threshold of a loss and the capital protection amount is established within the collected amount of the second type fund. Therefore, the investors investing in the first type fund do not suffer from a loss.

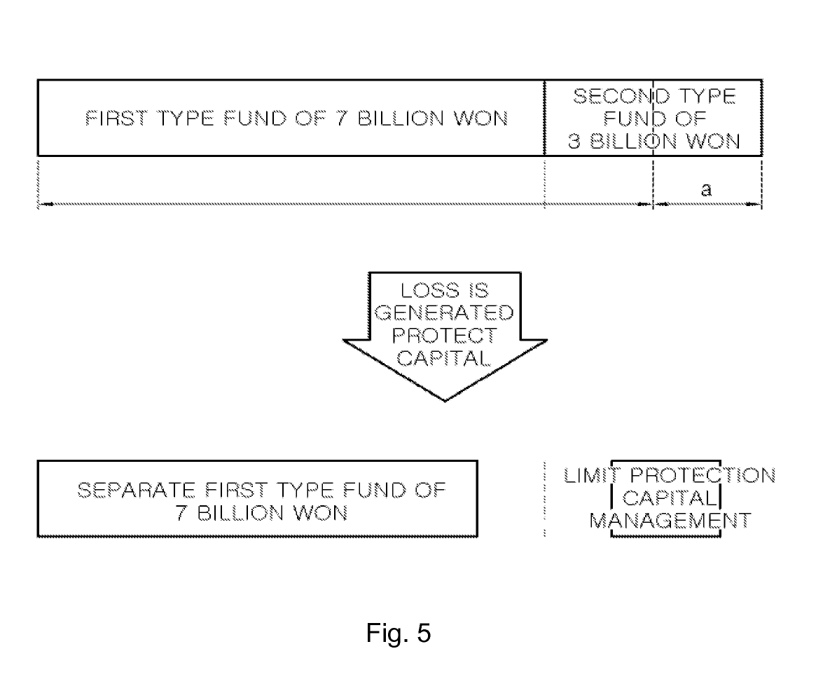

FIG. 5 is a diagram for describing an operation of the case in which the loss occurs in the state in which the capital protection amount is established as a in the fund management system 100 according to the present invention. As illustrated in FIG. 5, the collected amount of the first type fund is incorporated into the collected amount of the second type fund, and thus when a loss of a or more which is the capital protection amount occurs during managing the fund, the fund managing unit 20 according to the present invention first separates the collected amount of the first type fund and manages the fund using only the remaining amount. In this case, the funds of the separated first type fund are not invested in the investment target and are utilized as the payment reserves to increase the first type fund with a return, and the investor investing in the second type fund may continue the investment without the effect of the leverage due to the fund separation. As a result, the investors who select the first type fund may prevent a loss even though the rate of return is sacrificed and the investors who invest in the second type fund may continue investment using the summed funds of the second type fund even though a loss is accepted.

Herein, the capital protection amount may be established as a specific amount as described above, and may be established to be a specific ratio to the collected amount of the second type fund.

Further, a plurality of capital protection amounts may be established by the fund collecting unit 10 or the fund managing unit 20. That is, even in the case of the fund products having the same reference rate, when the capital protection amount is large, the fund management may be relatively more aggressively made, and therefore the fund products may be selected depending on the investor tastes, in consideration of the preset capital protection amount.

The return sharing unit 30 shares the return generated depending on the fund management using the fund managing unit 20 into the first type fund and the second type fund depending on the preset return sharing ratio.

The sharing of returns is basically made when a contracted period of fund products expires, and when the investor stops deferment or payment, the sharing of returns is not made unless the fund satisfies a predetermined condition such as a maintenance period.

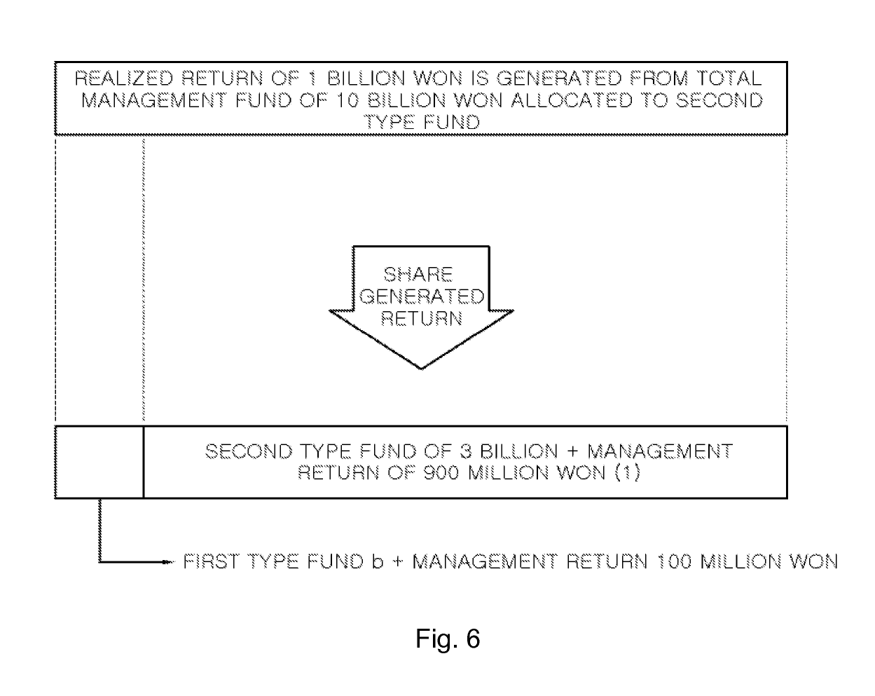

FIG. 6 is a diagram for describing a process of sharing, by a return sharing unit 30, a return when a return is generated by the fund management system 100 according to the present invention. When a return is generated by the summed fund managed by summing the collected amount of the first type fund and the collected amount of the second type fund, the return sharing unit 30 according to the present invention shares the total return with the investors, respectively, which subscribe to the first type fund and the second type fund depending on the preset ratio.

FIG. 6 illustrates a process of distributing the first type fund and the second type fund by a rate of return of 1:9 as an example of a rate of return at the time of sharing a return, in which the rate of return may be changed. Preferably, the return sharing unit 30 shares a higher return than the first type fund with the investor who subscribes to the second type fund, in consideration of a risk of investment.

Further, the return sharing unit 30 may share a return generated depending on the fund management, as well as the whole or a portion of the trading return such as sale commissions and management returns generated depending on the fund trading with the investors who subscribe to the first type fund, regardless of the return or loss of the fund. As a result, the investors who invest in the first type fund may secure a minimum return without a risk of loss even though the rate of return is lower than that of the second type fund.

The return sharing unit 30 according to the present invention has a priority of the return sharing, and therefore first shares the return generated depending on the fund management to investors, and then shares the trading return.

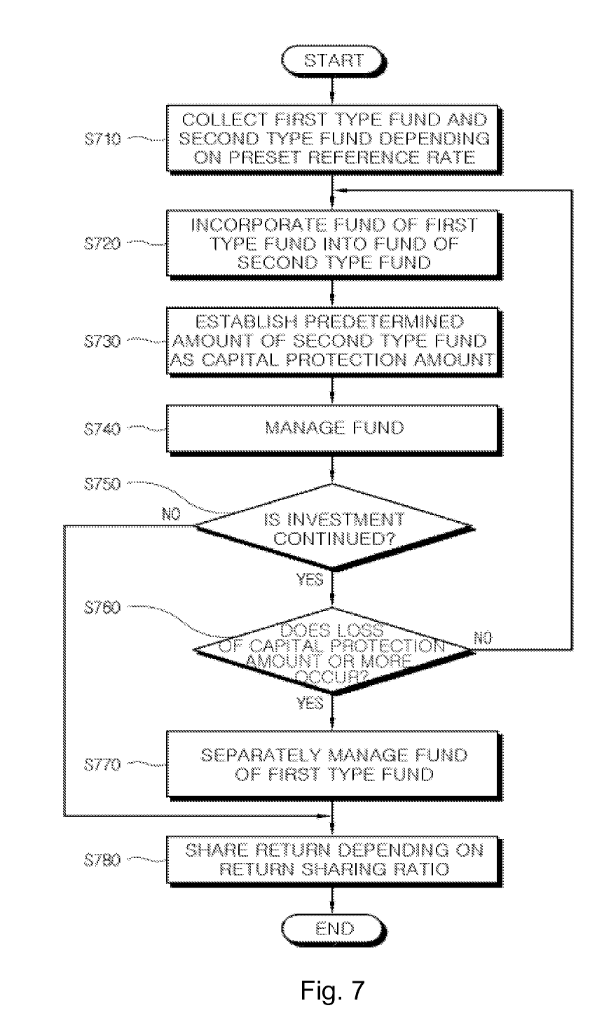

FIG. 7 is a flow chart illustrating a fund managing method according to the present invention. As illustrated in FIG. 7, the fund managing method according to the present invention first collects, by the fund collecting unit 10, the first type fund and the second type fund depending on the preset reference rate (S710).

Next, the fund managing unit 20 incorporates the funds collected through the first type fund into the funds collected through the second type fund (S720), and establishes the predetermined amount of the second type fund as the capital protection amount (S730). As a result, the fund managing unit 20 manages the collected fund (S740).

The fund managing unit 20 confirms whether the investor will continue the investment (S750), and if it is determined that the investor will continue investment, determines whether a loss of the capital protection amount or more occurs (S760). When the loss of the capital protection amount or more occurs, the funds collected through the first type fund are separately managed from the managed summed fund (S770).

If it is determined that the investor stops investment (S750), in step S780, a return is shared and settled depending on the investment result (S780).

When the loss of the capital protection amount or more does not occur, the fund managing unit 20 incorporates the funds of the first type fund into the funds of the second type fund to continuously manage the fund. Therefore, when the contracted period of the fund products expires, a return is shared with the first type fund and the second type fund, respectively. As a result, it is possible to prevent the loss of the fund invested in by the investor having the defensive investment taste. Herein, step S770 may further include automatically repurchasing the funds collected through the first type fund and the second type fund when the loss of the capital protection amount or more occurs.

Finally, the return generated depending on the fund management is shared with the first type fund and the second type fund depending on the preset return sharing ratio (S780). Herein, in connection with the sharing of return, the return generated depending on the fund management is first shared with the investor, and then a portion of the trading return generated depending on the fund trading is shared. Further, the incorporation of funds, the frequency and timing of the fund management, and the return sharing timing may be different depending on whether the fund products to which the investors subscribe are a lump sum type or a cost averaging type.

While the present invention has been described with reference to the preferred embodiments, it will be understood by those skilled in the related art that various modifications and variations may be made therein without departing from the scope of the present invention as defined by the appended claims.

1. A system of managing funds, comprising:
a fund collecting unit configured to collect a first type fund and a second type fund depending on a preset reference rate;
a fund managing unit configured to manage at least one of summed funds which are acquired by incorporating funds collected through the first type fund into funds collected through the second type fund and summing these funds, and establish a capital protection amount in the second type fund to separately manage the funds collected through the first type fund from the managed summed fund when a loss of the capital protection amount or more occurs; and
a return sharing unit configured to share a return generated depending on a fund management with the first type fund and the second type fund, respectively, depending on a preset return sharing ratio.

2. The system of claim 1, wherein the fund managing unit automatically repurchases the funds collected through the first type fund and the second type fund when a loss of the capital protection amount or more occurs.

3. The system of claim 1, wherein the fund managing unit incorporates at least a portion of the funds of the first type fund among management funds with a loss into the summed funds with a return based on the reference rate when a return is generated depending on the fund management to readjust an establishment amount of the first type fund and the second type fund and manage the funds.

4. The system of claim 1, wherein, when a loss occurs depending on the fund management, the return sharing unit shares at least a portion of trading returns including at least one of a sale commission and a management return which are generated by the collection of funds or the management of summed funds with the first type fund.

5. The system of claim 1, wherein a plurality of capital protection amounts are established by the fund collecting unit or the fund managing unit.

6. The system of claim 1, wherein the fund managing unit invests the fund of the collected fund in at least one of stock, futures and option products, and foreign products, or directly invests at least a portion of the funds managed by the second type fund in a trading market depending on a selection of an investor.

7. A method of managing funds, comprising:
collecting, by a fund managing unit, a first type fund and a second type fund depending on a preset reference rate;
incorporating, by a fund managing unit, the funds collected through the first type fund into the funds collected through the second type fund and summing these funds to manage at least one summed fund;
establishing, by the fund managing unit, a capital protection amount in the second type fund to manage the funds;
separating, by the fund managing unit, the funds collected through the first type fund from the managed summed funds when a loss of the capital protection amount or more occurs; and
sharing, by a return sharing unit, a return generated depending on the fund management with the first type fund and the second type fund, respectively, depending on a preset return sharing ratio.

8. The method of claim 7, wherein in the separating of the fund, the funds collected through the first type fund and the second type fund are automatically repurchased when a loss of the capital protection amount or more occurs.

9. The method of claim 7, wherein in the managing of the fund, when a return is generated depending on the fund management, at least a portion of the funds of the first type fund among the summed funds with a loss is incorporated into the summed funds with a return based on the reference rate to readjust an establishment amount of the first type fund and the second type fund and manage the funds.

10. The method of claim 7, wherein in the sharing of the return, when a loss occurs depending on the fund management, at least a portion of trading returns including at least one of a sale commission and a management return which are generated by the collection of funds or the management of summed funds is shared to the first type fund.

11. The method of claim 7, wherein in the managing of the fund, a plurality of capital protection amounts are established to manage the funds.

12. The method of claim 7, wherein in the managing of the fund, the fund of the collected fund invests to at least one of stock, futures and option products, and foreign products, or at least a portion of the funds managed by the second type fund directly invests to a trading market depending on a selection of an investor.

13. The system of claim 2, wherein the fund managing unit incorporates at least a portion of the funds of the first type fund among management funds with a loss into the summed funds with a return based on the reference rate when a return is generated depending on the fund management to readjust an establishment amount of the first type fund and the second type fund and manage the funds.

14. The system of claim 2, wherein, when a loss occurs depending on the fund management, the return sharing unit shares at least a portion of trading returns including at least one of a sale commission and a management return which are generated by the collection of funds or the management of summed funds with the first type fund.

15. The system of claim 2, wherein a plurality of capital protection amounts are established by the fund collecting unit or the fund managing unit.

16. The system of claim 2, wherein the fund managing unit invests the fund of the collected fund in at least one of stock, futures and option products, and foreign products, or directly invests at least a portion of the funds managed by the second type fund in a trading market depending on a selection of an investor.

17. The method of claim 8, wherein in the managing of the fund, when a return is generated depending on the fund management, at least a portion of the funds of the first type fund among the summed funds with a loss is incorporated into the summed funds with a return based on the reference rate to readjust an establishment amount of the first type fund and the second type fund and manage the funds.

18. The method of claim 8, wherein in the sharing of the return, when a loss occurs depending on the fund management, at least a portion of trading returns including at least one of a sale commission and a management return which are generated by the collection of funds or the management of summed funds is shared to the first type fund.

19. The method of claim 8, wherein in the managing of the fund, a plurality of capital protection amounts are established to manage the funds.

20. The method of claim 8, wherein in the managing of the fund, the fund of the collected fund invests to at least one of stock, futures and option products, and foreign products, or at least a portion of the funds managed by the second type fund directly invests to a trading market depending on a selection of an investor.
